(19) United States
(12) Patent Application Publication
(10) Pub. No.: US 2026/0150834 A1
(43) Pub. Date: Jun. 4, 2026

(54) REUSABLE ANTIMICROBIAL WIPES

(71) Applicant: Solomon Rosenblatt, Philadelphia, PA (US)

(72) Inventor: Solomon Rosenblatt, Philadelphia, PA (US)

(21) Appl. No.: 19/365,044

(22) Filed: Oct. 21, 2025

Related U.S. Application Data
(60) Provisional application No. 63/833,440, filed on Dec. 2, 2024.

(51) Int. Cl. A01N 25/34; A01N 25/10; A01N 59/12; A01P 1/00

(52) U.S. Cl. CPC A01N 25/34; A01N 25/10; A01N 59/12; A01P 1/00

(57) ABSTRACT

A solid iodophor configured as a reuseable non-cellulose antimicrobial wipe is disclosed herein. The antimicrobial wipe may be used to disinfect organic material on the surface of the skin or on other articles. The antimicrobial wipe may be rinsed with water and re-used multiple times while retaining an iodophor composition to release small microbicidal amounts of iodine with each use. The reusable wipe turns color from black to tan or white to indicate the need to replace the wipe or process with additional iodine to replenish the iodophor.

### REFERENCE TO RELATED APPLICATIONS

This application claims priority of U.S. Provisional Application No. 63/833,440 entitled “Polymeric, less soluble, broad spectrum absorbent, soft texture, control release iodophor” filed on Dec. 2, 2024, the disclosures of which are incorporated herein by reference in their entirety.

### BACKGROUND

### Technical Field

The disclosures herein relate to antimicrobial materials. Specifically, the disclosed invention relates to a non-cellulose, reusable polymeric foam wipe cloth complexed with iodine forming an iodophor composition.

### Background

There remains a need for a scientifically formulated medicinal wipe specifically dedicated to personal sanitizing and to professional treatment of facial blemishes and related skin conditions arising from bacterial colonization, and for a comparable consumer cosmetic wipe designed to support routine skin hygiene and maintain a healthy cutaneous biome.

Existing facial wipes marketed as “antimicrobial” generally lack proven, microbiologically effective agents capable of eliminating skin pathogens, including environmental microbes such as viruses, molds, and fungi that accumulate on the skin from contacted surfaces. Currently available formulations typically include surfactants, emulsifiers, oxidizers, organic acids, glycols, antioxidants, preservatives, and botanical extracts (e.g., tea tree, cucumber, coconut, or grapefruit). Although these ingredients provide cosmetic appeal, they do not exhibit true biocidal efficacy. Alcohol-based wipes, chlorine-based wipes, and peroxide wipes can be drying and irritating to the skin. Quaternary ammonium compound (“quat”) wipes are considered by the U.S. Centers for Disease Control and Prevention (CDC) to be secondary antimicrobials and potential skin irritants. Dermatologists have further reported that residues from these and other formulations may accumulate on the skin, leading to irritation or contamination rather than promoting skin health.

A wipe composition that delivers a clinically effective, broad-spectrum antimicrobial agent while maintaining biocompatibility and user comfort is needed. Such a product would serve both professional and consumer applications by providing a safe and effective means to cleanse, sanitize, and refresh the skin without leaving residues or causing irritation. Iodophor systems have demonstrated particular promise for achieving these goals. However, elemental iodine present in liquid iodophors is associated with staining and irritation.

Accordingly, there remains an unmet need for a scientifically validated, biocompatible antimicrobial skin wipe that effectively reduces microbial contamination, promotes skin health, and avoids the disadvantages associated with alcohols, quaternary ammonium compounds, other irritant compounds and cosmetic formulations lacking true biocidal efficacy. There is also a need utilizing the broad spectrum effectiveness of iodine by developing a non-irritating, non-staining form of iodine.

### BRIEF SUMMARY

Polyvinyl acetal iodine complexed materials are described in U.S. Pat. Nos. 5,071,648 and 11,446,408 AND METHODS OF FORMATION, the disclosures of which are incorporated entirely herein by reference. The current disclosures related to a reuseable, non-cellulose wipe based on these materials. The reuseable wipe comprising hydroxylated polyvinyl acetal iodine (“PVA-I”) exploits the beneficial properties of water-based broad-spectrum controlled-release biocidal iodine compositions contained in a reusable wipe. The reuseable sponge sheet is a solid iodophor which, when in a moistened state, releases small, biocompatible quantities of the iodine onto the skin or other surfaces in a controlled manner. The reusable sponge sheet turns color indicating depletion of the iodine content and need for replenishment.

The disclosures herein provide compositions and methods that enable a durable, highly absorbent, biocompatible hydroxylated polyvinyl acetal (“PVA”) polymeric sponge sheet (e.g., an antimicrobial wipe) complexed with iodine and configured for controlled release of elemental iodine. Various example embodiments are offered.

Disclosed herein is a reusable antimicrobial wipe comprising a non-cellulose polymeric absorbent sponge substrate chemically complexed with elemental iodine to form a solid iodophor. The moistened sponge sheet wipe iodophor is configured to release iodine in the presence of microorganisms. Also disclosed are kits comprising one or more of the antimicrobial wipes and a resealable storage pouch. Further disclosed are methods of using the wipes to sanitize or disinfect surfaces, including skin.

Disclosed is a reusable antimicrobial wipe comprising a non-cellulose polymeric sponge substrate; and elemental iodine, wherein the elemental iodine is complexed with the polymeric sponge substrate as a solid iodophor, and wherein the solid iodophor is configured to release the elemental iodine in a controlled manner in the presence of water and organic material.

In some embodiments, the non-cellulose polymeric sponge substrate comprises a synthetic durable absorbent carbohydrate-related polymer. In some embodiments, the polymeric sponge substrate comprises a polyvinyl alcohol polymer. In some embodiments, the polymeric sponge substrate comprises a starch acrylic polymer.

In some embodiments, the elemental iodine is released at a concentration of about 1 to about 5 parts per million. In some embodiments, the elemental iodine is released at a concentration of about 2 to about 3 parts per million. In some embodiments, the elemental iodine remains complexed to the polymer upon repeated use, including washing and drying cycles.

In some embodiments, the wipe is configured as a flexible sheet or sponge. In some embodiments, the antimicrobial wipe provides antiseptic, disinfectant, or sterilant activity upon application to a surface or skin. In some embodiments, the organic material comprises microorganisms. In some embodiments, the microorganisms treated comprise one or a combination of bacteria, viruses, yeast, fungi, spores, and protozoan parasites. In some embodiments, the wipe is effective to disrupt biofilms on a surface or skin. In some embodiments, the iodine content maintains the wipe in a self-sterilizing state, inactivating trapped surface microorganisms on the wipe during storage and use.

Disclosed is a kit comprising one or more antimicrobial wipes comprising a non-cellulose polymeric sponge substrate and an iodophor complex with elemental iodine and a resealable pouch configured to retain moisture and maintain the wipe in a ready-to-use state.

In some embodiments, the iodine content of the wipe inactivates microorganisms present on the wipe during storage and use thereby maintaining the wipe in a self-sterilizing state.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 is an illustration depicting a method of forming a reuseable non-cellulose antimicrobial wipe formed from a polymeric material containing an iodophor composition.

### DETAILED DESCRIPTION

Disclosed herein is a medicinally designed two-component wipe or sponge device configured to simultaneously sanitize the skin during contact with its contained antimicrobial composition. The present invention utilizes a new source of iodine that can maintain iodine's broad-spectrum antimicrobial properties in a biocompatible form. This design enables the mechanical removal of debris and contaminants while delivering a biocidal effect to the skin surface. Importantly, the composition can be formulated to eliminate the undesirable properties associated with conventional personal sanitizing antimicrobials while retaining superior biocidal performance.

Various example embodiments of polymeric iodophor compositions and methods of use therefor are disclosed. These compositions are based on an amylose-containing acrylic polymer complexed with elemental iodine. The amylose-iodine complex acts as an iodine reserve, incorporating large amounts of elemental iodine but releasing only small, non-toxic amounts into the wound over a long time period. The absorptive starch carrier is also non-toxic and safe as manifest by the use of saponified starch or starch-like acrylic polymer gels as a pharmaceutical diluent and as viscous inert carriers for in sustained drug delivery compositions. The amylose-acrylic starch polymer coating acts as a super-absorbent starch polymer (“SAP”) that pulls exudate from the wound surface, holding over eighty times its dry weight in water. Moreover, the amylose-iodine binding starch-acrylic polymer composition can be incorporated into a non-cellulose polyvinyl alcohol wipe to which the iodine composition is combined for controlled release when the reuseable wipe is moistened with water. Because the iodine is bound within the starch acrylic polymer coating, the polyvinyl alcohol material forming the wipe base because of the very low aqueous solubility of the iodine-PVA complex in water, rinsing the sponge wipe does not wash out the bound iodine. Because the iodine is also bound to the sponge polymer, the wipe lacks the typical iodine odor and is non-staining. Wiping the skin or other surface with the wipe causes the release of small quantities of iodine sufficient to disinfect the surface without odor or staining. The wipe may be reused many times. The longevity of the wipe's effectiveness as a biocide is dependent of on quantity of microorganisms and other organic material contacting the iodophor over time. The wipe may be washed with water when soiled with organic material, and may be re-moistened with water if the wipe becomes dried, abrasive, or brittle while retaining its iodine-releasing properties. When the wipe become depleted of its iodine, the color changes from black or reddish brown to light tan or white, indicating the need to replace the wipe.

### Definitions

Certain terms should be afforded their broadest reasonable meaning as interpreted by a person of skill in the art. For example, “optionally” is intended to introduce a non-limiting example. The phrases “in one embodiment” and “in some embodiments” do not necessarily refer to the same embodiment(s), although they may. Furthermore, the phrases “in another embodiment” and “in some other embodiments,” as used herein, do not necessarily refer to a different embodiments, although they may. The various example embodiments as described herein may be readily combined without departing from the scope or spirit of the disclosed inventions. The term “or,” unless otherwise specified, is inclusive and is equivalent to “and/or.” The term “based on” is not exclusive and allows for use based on additional factors not described unless the context clearly dictates otherwise. Throughout the written description, the meaning of “a,” “an,” “and “the” include plural references. The meaning of “in” includes “in” and “on.” The terms “comprises” and “comprising,” as used herein, specify that certain features are present in the described embodiment(s), however this phrase should not be interpreted to preclude the presence or addition of additional step, operations, features, components, and/or groups thereof.

The several example embodiments disclosed herein are written for use in a healthcare setting, however this is not meant to be limiting. In some embodiments, other uses are employed.

As used herein, “upper” refers to a direction away from or further from a more central part. For example, away from the body and toward the outer, more superficial surface of a wound or a dressing.

As used herein, “lower” refers to a direction toward a more central part. For example, closer to the body and toward the more central, deeper aspects of a wound or a dressing, away from the surface or the wound or the body.

Any directional references as used herein, such as right, left, up, down, top, bottom, and the like are intended for convenience of description and do not limit the disclosed structures to any particular positional or spatial orientation.

As used herein, “povidone” means polyvinylpyrrolidone.

As used herein, “iodophor” means a composition containing elemental iodine and a liquid or solid complexing agent. A prominent example of an iodophor from the prior art is polyvinylpyrrolidone liquid—i.e., “povidone iodine” or “PVP-I.” Iodophors release elemental iodine gradually in a sustained-release manner. Iodine and, consequently, iodophors, are bactericidal and viricidal in relatively small concentrations. A solid-state example of an iodophor is the combination of iodine with the PVA sponge wipe to form an iodine-PVA complex.

As used herein, “antimicrobial,” “germicidal,” and “biocidal” are used interchangeably.

With the foregoing background, summary, and definitions in mind, what follows is a detailed discussion disclosing various example embodiments.

### Non-Cellulose Reuseable Antimicrobial Wipes

In some embodiments, the non-cellulose reuseable antimicrobial wipe comprising essentially, a non-cellulose polymeric sponge substrate and elemental iodine forming a sponge (solid) iodophor. The substrate is hydroxylated polyvinyl acetal, in some embodiments. In some embodiments, the iodine is configured to be released in the presence of organic material, such as microorganisms, including bacteria, viruses, or the like. Without wishing to limit the present invention to any theory or mechanism, it is believed that iodine remains complexed to the PVA in the absence of organic material, such that iodine release occurs primarily upon contact with organic matter, thereby extending the effective lifespan of the wipe. Furthermore, because the iodine is chemically complexed with the PVA rather than merely coated or impregnated, the iodine does not leach or wash out in a substantial quantity when the wipe is moistened or rinsed with water. Moistening the wipe is essential for activating and transferring iodine to a surface, such as the skin, in the presence of organic material.

In some embodiments, the antimicrobial wipes are configured as a flexible absorbent sheet or sponge.

In some embodiments, the elemental iodine remains complexed to the polymer upon repeated wetting and drying cycles.

In some embodiments, the non-cellulose polymeric sponge substrate additionally comprises a synthetic carbohydrate-related polymer. In some embodiments, the non-cellulose polymeric sponge substrate comprises a polyvinyl alcohol polymer. In further embodiments, the polymeric sponge coating comprises a starch acrylic polymer.

In some embodiments, the antimicrobial wipe releases a germicidal concentration of iodine, on the order of a few parts per million (ppm), upon contact with organic material. For example, in some embodiments, the antimicrobial wipe releases the elemental iodine at a concentration of about 1 to 5 ppm, or about 1 to 4 ppm, or about 1 to 3 ppm, or about 1 to 2 ppm. In other embodiments, the antimicrobial wipe releases the elemental iodine at a concentration of about 2 to 5 ppm, or about 2 to 4 ppm, or about 2 to 3 ppm. In some embodiments, the antimicrobial wipe releases the elemental iodine at a concentration of about 3 to 5 ppm, or about 3 to 4 ppm, or about 4 to 5 ppm. By contrast, conventional iodine-containing products available in drug stores may contain up to 20,000 ppm of iodine. However, excess iodine does not necessarily enhance germicidal activity and can instead cause undesirable effects such as burning, toxicity in open wounds, odor, and staining. Accordingly, prior references teach away from the present invention, which provides effective antimicrobial activity at significantly lower, non-irritating iodine concentrations. Additionally, the present invention provides a means of delivering iodine that lacks the typical iodine odor and is non-staining.

The iodine released by the antimicrobial wipes described herein inactivates or kills microorganisms, such as bacteria, through multiple mechanisms. For example, in some embodiments, the iodine released by the antimicrobial wipes may kill or inactivate microorganisms, such as bacteria, through oxidation, thereby sanitizing the contacted surface. In other embodiments, iodine binds to cell wall proteins, causing cell wall rupture; reacts with intracellular enzymes, leading to cellular dysfunction; denatures microbial DNA, halting replication; and disrupts DNA scaffolding in biofilms, exposing embedded bacteria to iodicidal effects. These combined actions provide broad-spectrum antimicrobial activity. Thus, in certain embodiments, the antimicrobial wipe provides antiseptic, disinfectant, or sterilant activity upon application to a surface or skin.

In some embodiments, the reuseable non-cellulose antimicrobial wipes described herein may disrupt or penetrate biofilms, for example, by targeting the extracellular DNA scaffolding matrix. This mechanism allows the wipes to inactivate bacteria embedded within biofilms, which are typically more tolerant to antibiotics and conventional antimicrobial products. Accordingly, in some embodiments, the present wipes provide enhanced antimicrobial activity against biofilm-associated bacteria.

In some embodiments, the antimicrobial wipe is initially black. As the iodine content in the wipe is gradually depleted—for example after repeated use—the wipe changes color from black to white. The rate of color change may depend on factors such as the level of organic material on the surface (e.g., skin) and the number of uses. This color transition provides a convenient visual indicator of the wipe's remaining antimicrobial effectiveness and can signal when the wipe should be replaced or recharged with iodine. In certain embodiments, the iodine content maintains the wipe in a self-sterilizing state, inactivating microorganisms on the wipe during storage and use.

In some embodiments, the antimicrobial wipes are configured to leave a minute amount of residual iodine on the skin or other contacted surface which acts as a protective presence on the skin, discouraging re-infections or bacterial growth.

In some embodiments, the antimicrobial wipes described herein apply a thin, moist sanitizing layer to the skin, providing enhanced efficacy against a broad spectrum of skin-damaging microorganisms compared to conventional products. In contrast, alcohol-based antimicrobials rapidly evaporate upon application, significantly reducing germicidal activity. Studies have shown that even thoroughly wet alcohol swabs reduce general bacterial counts by only about 70%, leaving many resistant bacteria and viruses unaffected. Alcohol is largely ineffective against certain viruses and spores, and kills microorganisms primarily by denaturation or dehydration. Frequent alcohol exposure can dry out the skin, compromise its natural barrier, and increase susceptibility to infection, while leaving no residual antimicrobial protection. Thus, the iodophor-based wipes disclosed herein deliver a continuous and controlled aqueous concentration of iodine that remains active in the presence of organic material, providing sustained germicidal activity without drying the skin and without leaving residues that compromise barrier function.

In some embodiments, the antimicrobial wipes function as an antiseptic to prevent infection, as a disinfectant to kill germs, or as a sterilant to inactivate microorganisms on predominantly inanimate surfaces, such as surgical or medical instruments or devices. In certain embodiments, the wipes may be used as a wrap to sterilize articles. In contrast, conventional products, such as alcohol or chlorine-based or quaternary ammonium-based (“quat”) wipes, are typically limited to disinfectant activity, whereas the iodophor wipes described herein can deliver any one or a combination of broad spectrum and can deliver any combination of antiseptic, disinfectant, and sterilant effects at relatively low but effective concentrations, e.g., about 2 to 3 ppm.

In some embodiments, the present invention features a kit comprising one or more antimicrobial wipes as described herein and a resealable plastic pouch. Without wishing to limit the present invention to any theory or mechanism, the resealable pouch may maintain the wipes in a moist state, preserving their antimicrobial effectiveness for subsequent uses. The iodine content of the wipes provides self-sterilizing activity, such that microorganisms present on the wipe are inactivated both during storage and after use, leaving the wipe fresh for its next application. In certain embodiments, the pouch is designed for portability and convenience, allowing it to be carried in a handbag or pocket, and may include printed instructions or branding information.

In some embodiments, the present invention features methods of using the antimicrobial wipes described herein to sanitize a surface, such as a hard surface, or to sanitize the skin. In certain embodiments, the antimicrobial wipe is used personally to sanitize the skin of the hands and face, rather than for cleaning hard surfaces. For example, the wipe may be used as a portable, personal sanitizer after contact with public handles and surfaces, such as after handshakes, keyboards, cell phones, restaurant cutlery, or touching handrails, doorknobs, or similar objects, rather than for pre-cleaning such surfaces. The wipe is not intended to remove visible debris or makeup.

In some embodiments, the method comprises contacting a surface or skin with the antimicrobial wipe for a period of time, e.g., at least about 10 seconds. In some embodiments, the wipe is applied to the surface or skin using gentle pressure in a wiping or cleansing motion. During use, the surface or skin becomes dampened by the contained water/iodine mixture, which evaporates while delivering antimicrobial activity to a surface. The wipe may be stored in the provided resealable plastic pouch to maintain moisture and preserve antimicrobial effectiveness for subsequent uses.

The PVA-I solid iodophor is a broad-spectrum antimicrobial. Standardized Kirby-Baur disk diffusion tests were performed using a equal-sized small sample disks of PVA-I sponge wipe material. The results are reproduced in Table I below:

TABLE 1

| | Degree of |
|---|---|
| Microbe (no. of strains) | Inhibition |
| Candida tropicalis (1) | 3+ |
| Clostridium perfringens (2) | 3+-4+ |
| Proteus vulgaris (3) | 3+-4+ |
| Pseudomonas aeruginosa (4) | 2+-4+ |
| Pseudomonas cepacia (4) | 2+-4+ |
| Bacillus sp (2) | 3+ |
| Candida albicans (3) | 3+ |
| Candida kreusii (1) | 3+ |
| Pseudomonas maltophilia (1) | 3+ |
| Streptococcus pneumoniae (1) | 4+ |
| Escherichia coli (8) | 4+ |
| Streptococcus agalactiae (1) | 4+ |
| Corynebacterium spp. (3) | 4+ |
| Bacteroides fragilis (1) | 4+ |
| Staphlococcus epidermidis (1) | 4+ |
| Acinetobacter anitratus (1) | 4+ |
| Citrobacter freundii (1) | 4+ |
| Shigella sonnei (1) | 4+ |
| Kluyvera ascorbata (1) | 4+ |
| Enterobacter agglomerans (1) | 4+ |
| Enterobacter cloacae (2) | 4+ |
| Morganella morganii (1) | 4+ |
| Serratia odorifera (2) | 4+ |
| Klebsiella oxytoca (2) | 4+ |
| Torulopsis glabrata (3) | 4+ |
| Klebsiella pneumoniae (3) | 4+ |
| Serratia marcescens(4) | 4+ |
| Serratia rubidaea | 4+ |
| Providencia sp. (1 | 4+ |
| Proteus mirabilis (2) | 4+ |
| Enterobacter aerogenes (2) | 4+ |
| Enterobacter Sakazakii (1) | 4+ |
| Yersinia enterocolitica (1) | 4+ |
| Salmonella enteritidis (1 | 4+ |
| Staphylococcus aureus (1) | 4+ |
| Streptococcus pyogenes (Gp A) (2) | 4+ |
| Lactobacillus sp (2 | 4+ |
| Clostridium sordellii (1) | 4+ |

In some embodiments, if the wipe becomes slightly dry or stiff after being stored outside of its resealable pouch, it may be rehydrated by lightly dampening it with water and gently squeezing to distribute the moisture evenly throughout the wipe before returning it to the pouch. The wipe should remain moist, but not overly saturated, during storage and use.

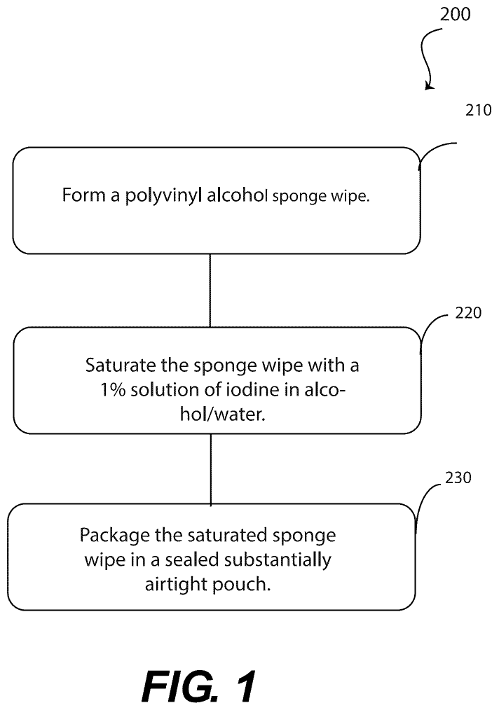

FIG. 1 is an illustration depicting a method of forming a reuseable non-cellulose antimicrobial wipe formed from a polymeric material containing an iodophor composition. FIG. 1 shows method 200 comprising a forming step 210, a saturating step 220, and a packaging step 230.

Step 210, in some embodiments, comprises forming a solid iodophor sponge wipe. In some embodiments, the solid iodophor comprise a polyvinyl alcohol sponge. In some embodiments, forming step 210 includes formation of a 2 to 3 millimeter thick sponge, which may have a generally square shape having dimensions of about six (6) inches by about six (6) inches in some non-exclusive example embodiments. In some embodiments, the sponge comprises polyvinyl alcohol. In some embodiments, the sponge comprises an amylose-based acrylic.

Saturating step 220 comprising saturating the sponge wipe with a 2% solution of iodine and 4% potassium iodide. In some embodiments, saturating step 220 comprises soaking the sponge in a sufficient quantity of an iodine-containing aqueous solution or suspension until the sponge material can absorb and retain no additional quantity of the iodine-containing solution. After soaking for a time interval between about one (1) minute and about (1) hour, the aqueous solution or suspension is allowed to drain from the sponge material. The sponge material is then gently rinsed with water to remove any remaining solution or suspension containing un-complexed iodine. In some embodiments, the iodine-containing solution is an aqueous mixture iodine and potassium iodide (KI) at a concentration of iodine between about one percent (1%) and about five percent (5%). Following the gentle water rinse, in some embodiments, saturating step 220 additionally comprises impregnating the sponge with a powder of amylose-containing super absorbent acrylic polymer.

Packaging step 230 comprises packaging the sponge wipe in a sealed substantially airtight storage pouch. In some embodiments, the pouch is resealable, such as a pouch fitted with a zip-lock sealing mechanism.

In certain embodiments, the antimicrobial wipes described herein may be used for personal and routine sanitization with cooling refreshment, such as also to kill germs on the hands and face and help prevent the spread of infection. In some examples, the wipes may be used after touching public surfaces (e.g., bathroom doors, handles, knobs, telephones, computer keyboards, handrails, banisters, gym and locker room equipment, or shopping cart handles).

In some additional embodiments, the reuseable antimicrobial wipes may be used in healthcare or wellness facilities (e.g., acupuncture clinics, chiropractic offices, nursing homes, commercial aircraft, cruise ships, medical offices, or hospitals, and the like) by practitioners as an alternative to alcohol-based gels, which may dehydrate the skin and increase susceptibility to cracking with frequent use. In certain embodiments, the wipes may be used for baby care applications, such as sanitizing the skin during nursing or cleaning the breast or nipple area.

In further embodiments, the wipes may be used for antimicrobial cleansing of the face and eyelids, for example, in the treatment of bacterial eyelid or eyelash infections (e.g., blepharitis) and other conditions where alcohol-based products are precluded.

The embodiments and examples set forth herein were presented in order to best explain the present invention and its practical application, and to thereby enable those of ordinary skill in the art to make and use the inventions as disclosed herein. However, those of ordinary skill in the art will recognize that the foregoing description and examples have been presented for the purpose of illustration and example. The description as set forth is not intended to be exhaustive or to limit the invention to the precise form disclosed. Many modifications and variations are possible, in light of the teachings herein above.

What is claimed is:

1. A reusable antimicrobial wipe comprising:
a non-cellulose polymeric sponge substrate; and
elemental iodine,
wherein the elemental iodine is complexed with the polymeric sponge substrate as a solid iodophor, and
wherein the solid iodophor is configured to release the elemental iodine in a controlled manner in the presence of water and organic material.

2. The wipe of claim 1, wherein the non-cellulose polymeric sponge substrate comprises a synthetic carbohydrate-related polymer.

3. The wipe of claim 1, wherein the polymeric sponge substrate comprises a polyvinyl alcohol polymer.

4. The wipe of claim 1, wherein the polymeric sponge substrate comprises a starch acrylic polymer.

5. The wipe of claim 1, wherein the elemental iodine is released at a concentration of about 1 to about 5 parts per million.

6. The wipe of claim 1, wherein the elemental iodine is released at a concentration of about 2 to about 3 parts per million.

7. The wipe of claim 1, wherein the elemental iodine remains complexed to the polymer upon repeated wetting and drying cycles.

8. The wipe of claim 1, wherein the wipe is configured as a flexible absorbent sheet or sponge.

9. The wipe of claim 1, wherein the antimicrobial wipe provides antiseptic, disinfectant, or sterilant activity upon application to a surface or skin.

10. The wipe of claim 1, wherein the organic material comprises microorganisms.

11. The wipe of claim 10, wherein the microorganisms comprise one or a combination of bacteria, viruses, yeast, fungi, spores, and protozoan parasites.

12. The wipe of claim 1, wherein the wipe is effective to disrupt biofilms on a surface or skin.

13. The wipe of claim 1, wherein the iodine content maintains the wipe in a self-sterilizing state, inactivating microorganisms on the wipe during storage and use.

14. A kit comprising:
one or more antimicrobial wipes according to claim 1; and
a resealable storage pouch configured to retain moisture and maintain the wipe in a ready-to-use state.

15. The kit of claim 14, wherein the iodine content of the wipe inactivates microorganisms present on the wipe during storage and use thereby maintaining the wipe in a self-sterilizing state.
